(19) United States
(12) Patent Application Publication
(10) Pub. No.: US 2008/0199739 A1
(43) Pub. Date: Aug. 21, 2008

(54) Electrochemical cell stack and a method of forming a bipolar interconnect for an electrochemical cell stack

(75) Inventors: Robin Edward Clarke, Elwood (AU); Sarbjit Singh Giddey, Glen Waverley (AU); Sukhvinder P.S. Badwal, Clayton (AU)

Correspondence Address: LAHIVE & COCKFIELD, LLP, ONE POST OFFICE SQUARE, BOSTON, MA, 02109, US

(73) Assignee: Commonwealth Scientific and Industrial Research Organisation, Campbell (AU)

(21) Appl. No.: 11/708,233

(22) Filed: Feb. 20, 2007

(51) Int. Cl. H01M 8/02

(52) U.S. Cl. 429/12; 29/623.1

(57) ABSTRACT

A method of forming a bipolar interconnect for a polymer electrolyte membrane fuel cell or electrolyser stack. The method includes providing a planar electrically-conductive blank, and deforming a portion of the conductive blank to provide a raised part on the blank defining an electrical contact and a fluid flow channel.

### FIELD OF THE INVENTION

The present invention relates to electrochemical cells assembled into stacks and, in particular to polymer electrolyte membrane electrolyser stacks and polymer electrolyte membrane fuel cell stacks. The invention particularly relates to a method of forming a bipolar separator (interconnect) for these stacks.

### BACKGROUND OF THE INVENTION

The predominant design of conventional PEM fuel cells and electrolysers takes the form of a stack of numerous planar cells set one beside the other. This arrangement places the cells electrically in series, so that the same current flows through all cells and the overall voltage is the total of the individual cell voltages. Each such cell is bordered by a “plate” that serves many simultaneous functions. These include the provision of mechanical support and strength, sealing in the liquids and gases that flow inside each cell and the provision of gas (and liquid) flow paths as well as electrical contact points to the electrode assembly at the core of the cell. Whilst this functionality could conceivably be achieved by a multi-component assembly, there are a number of reasons why it is generally preferable to carry out all these functions with a single component. The performance requirements on this component are stringent. They include high corrosion resistance, low electrical resistivity and gas tightness. For a number of reasons, including corrosion performance, titanium metal is the preferred material. Stainless steel and other metals or alloys, possibly with protective coatings, may also be used. The flow channels are generally machined.

It is further beneficial for design efficiency if the same machined component that forms the positive plate of one cell can simultaneously fulfil the role of negative plate for the next cell in the stack. This component therefore links adjacent cells and is often referred to as a separator. If it is double sided, or “bipolar” and it automatically fulfils the role of electrically connecting one cell to the next, it may be termed a “bipolar interconnect”.

Machined interconnects are usually bipolar and are generally in the range 3 mm to 10 mm thick. For cells of about 100 cm² and larger, efficient designs tend to use flow channels that are of the order of 1-2 mm wide and contact ridges between these flow channels are also of the order of 1-2 mm wide.

Machining of fuel cell and electrolyser interconnects is a costly process. For efficient operation, gas flow channels must be quite closely spaced and have a relatively complex shape which is expensive and time consuming to produce. In addition, conventional interconnects are machined from a relatively thick plate to accommodate channels machined into both sides. Conventional interconnects are therefore relatively heavy which results in an assembled stack which is bulky and has high material costs.

### SUMMARY OF THE INVENTION

It is an object of the present invention to provide a bipolar interconnect which is relatively compact, low in weight, inexpensive to produce, and fabricated from a single component.

In accordance with a first aspect of the present invention, there is provided a method of forming a bipolar interconnect for an electrochemical cell stack, the method including: providing a planar electrically-conductive blank; and deforming a portion of the conductive blank to provide a raised part on the blank defining an electrical contact and a fluid flow channel.

Preferably, the portion is deformed to provide a raised part in the form of a series of corrugates, defining a plurality of electrical contacts and a plurality of fluid flow channels.

The blank is preferably a blank of sheet metal between 0.4 and 1.0 mm thick.

Preferably, the deforming of the portion can include a first pressing operation including pressing the portion of the conductive blank between complementary dies and heating the conductive blank to a predetermined temperature.

Preferably, the method also includes flattening each electrical contact to increase its contact area and reduce warp. The flattening of each electrical contact preferably can include a second pressing operation using a second set of dies and/or grinding the associated contact area.

One side of the series of corrugates can be associated with an anode of an electrochemical cell in the stack and an opposing side can be associated with a cathode of an adjacent electrochemical cell of the stack. In one embodiment, the series of corrugates is asymmetrical, one side of the blank having one more electrical contact than an opposing side. In another embodiment, the blank has a series of corrugates on two opposing sides, the two series of corrugates being asymmetrical, the series of corrugates on one side of the blank being laterally displaced from the series of corrugates on the opposing side.

The conductive blank preferably can include a periphery bounding the series of corrugates, the periphery lying substantially in a central plane such that the corrugates extend about the central plane.

Preferably, at least one flow port is formed in the blank. Any required flow ports can be formed in the periphery around the series of corrugates. Flow ports can be formed by one of a punching operation and a drilling operation. The conductive blank can be formed of a metal. The metal can be one of titanium, stainless steel, mild steel, nickel, copper and alloys thereof. The metal can be coated with a corrosion resistant material. The metal can also be coated with a low contact resistance material.

The raised part can be one of spiral, serpentine, counter or co-flow. The raised part can be in the form of a predetermined number of ridges, defining a predetermined number of electrical contacts and a predetermined number of fluid flow channels.

A plurality of raised parts can be provided on the blank to allow the blank to make electrical contact with a plurality of electrochemical cells in parallel.

In accordance with another aspect of the present invention, there is provided a bipolar interconnect for an electrochemical cell stack formed using the method described above.

In accordance with a further aspect of the present invention, there is provided an electrochemical cell stack including: a plurality of electrochemical cells arranged in a stack; a plurality of bipolar interconnects, each interconnect being disposed between adjacent cells and including a series of pressed corrugates such that each corrugate defines an electrical contact and a fluid flow path, wherein one side of the series of corrugates is associated with an anode of one of the electrochemical cells and the other side of the series of corrugates is associated with a cathode of an adjacent cell.

In one embodiment, the series of corrugates is asymmetrical, one side of the blank having one more electrical contact than an opposing side. In another embodiment, the blank has a series of corrugates on two opposing sides, the two series of corrugates being asymmetrical, the series of corrugates on one side of the blank being laterally displaced from the series of corrugates on the opposing side. Consecutive interconnects are preferably arranged back-to-back such that opposing electrical contacts are preferably aligned.

The electrochemical cell stack can include a header channel interconnecting at least some of said fluid flow channels.

The interconnects can be more than 0.4 mm thick and preferably of sufficiently high thermal conductivity for uniform heat distribution and heat removal. The interconnects are of reasonable thickness to provide adequate thermal conductance for safe operation of each cell, minimizing local hot spots which can arise with thinner plates and allowing heat generated within the cell to be uniformly distributed and transported by conduction to external surfaces.

### BRIEF DESCRIPTION OF THE DRAWINGS

Benefits and advantages of the present invention will become apparent to those skilled in the art to which this invention relates from the subsequent description of exemplary embodiments and the appended claims, taken in conjunction with the accompanying drawings, in which:—

FIG. 1 illustrates schematically an electrochemical stack, in accordance with an embodiment of the invention;

FIG. 2 illustrates a plan view of a bipolar interconnect, in accordance with an embodiment of the invention;

FIG. 3 illustrates a side view of the bipolar interconnect of FIG. 2;

FIG. 4 illustrates an end view of the bipolar interconnect;

FIG. 5 illustrates schematically the steps in a method of forming a bipolar interconnect for an electrochemical stack; and

FIG. 6 illustrates an enlarged view of a die set for forming a bipolar interconnect.

### DESCRIPTION OF THE PREFERRED AND OTHER EMBODIMENTS

Referring to the drawings, an electrochemical cell stack 1 includes a plurality of cells 2. In the embodiment shown in the drawings, the stack includes three cells arranged in series such that the same current flows through all cells and the total voltage of the stack 1 is the sum of the individual cell voltages. It will be appreciated that stacks in accordance with the invention may be formed with any required number of cells.

A bipolar interconnect 3 is disposed between adjacent cells 2 to provide mechanical support and electrical contacts for the cells, and to seal in and direct the flow of fluids throughout the cell.

Each interconnect 3 includes a raised part, in the form of a series of pressed corrugates 4, such that each corrugate defines an electrical contact 5 and a fluid flow-path 6. One side 7 of the series of corrugates 4 is associated with an anode 8 of one of the cells 2 and the other side 9 of the series of corrugates is associated with a cathode 10 of an adjacent cell.

The cells are photon exchange membrane (PEM) electrochemical cells having a polymer electrolyte membrane. The cells may be fuel cells or electrolysis cells, whereby, electrochemically, one is the reverse of the other. The two types have many common elements and some cells are able to operate in both modes. In the cell, electrodes (not shown) containing appropriate catalysts are located at either side of a thin PEM membrane 11. In the electrolysis mode, water is disassociated into protons (hydrogen ions) at the anode 8 and oxygen molecules are liberated on this side of the membrane electrode assembly (MEA). The electrons flow through the external circuit. The applied potential induces a flow of H⁺ ions through the membrane (along with some liquid water) to the electrode at the other side of the membrane. Here the protons take up electrons supplied through the external electrical circuit, are converted to molecular hydrogen in the gaseous form which is liberated at this side of the cell.

The interconnect 3 seals the cell 2 to contain the fluid in the form of water and gases. The interconnect contains flow channels and entry/exit connections to manage the flow of water and gases into and out of the cell and across the active electrode surface. The interconnect also provides electrical contact to the electrode in a way that does not hinder the exposure of the surface of the membrane to gas and water as well. This is generally achieved by using closely-spaced contact ridges or high points, interspersed with low points which form gas/liquid flow channels. An electrically-conducting gas diffusion layer (GDL) is generally also present, in contact with the interconnect ridges, to assist in allowing gas, water and electrons to be simultaneously present at all active locations on the electrodes on either side of the cell.

Fuel cells and electrolysers generally utilize a variety of geometries for the flow channels. Some do not use structured channels, relying instead on bulk flow across an open metal gauze or other conductive material. There may be interdigitated (closed end) channels where there is some directed flow along the channels and some bulk flow across a metal gauze. Some geometries are “rectilinear” with parallel flow channels and header channels at right angles to them at either end. Other designs may be in spiral or serpentine form whilst others may incorporate complex paths around other cell components such as ports and fixing bolts. The pressed bipolar interconnect of this invention may also use a variety of these patterns. The geometry, as demonstrated in FIGS. 2, 3 and 4, may be referred to as “counterflow”, having regard to the likely flow directions on either side of the plate. The pressing results in the ridges (electrode contact areas) on one face being simultaneously the valleys (gas flow channels) on the opposite face. The design is therefore reversible in that the ridges and valleys protrude either side of a central plane of the material.

The periphery of the interconnect plate which bounds the series of corrugates (the active region) is a flat planar shape to enhance sealing around the periphery. In addition, the ridges and valleys must end within the active area to allow for header channels (not shown) to distribute the gas/liquid flows into the valleys. These header channels must be constructed within the flat (planar) area so that the requirement of reversibility is met. Such in-plane headers have channels which are necessarily thinner than the fluid flow-channels in the active area. This will restrict the fluid flow and must be taken into account in the design.

As stated, a further aspect of the design is that it can be made with ridge spacings that have been found to be optimum. This will depend on many aspects of the cell design but is typically a 2-4 mm pitch (alternating 1-2 mm ridges and 1-2 mm valleys). FIGS. 2, 3 and 4 show a typical design of a bipolar pressed plate interconnect for a small electrolyser using a simple counterflow design. FIG. 6 shows detail of how the ridges and valleys are formed by pressing within a pair of dies 12. Following pressing or stamping, the metal bipolar plate remains substantially planar around the perimeter of the active area.

The interconnect is formed from a planar conductive blank in the form of a metal sheet (typically between 0.4 mm and 1.0 mm) which is pressed to form the gas flow channels and electrode contact areas. The pressing process uses dies 12 which enable creation of an optimum profile without fracturing the material. The symmetric design of the pressing is inherently “bipolar” so that both sides are formed simultaneously since the depressions on each side (creating the gas flow channels) are simultaneously present with the electrode-contact ridges on each opposite face. The method of forming the bipolar interconnect may be performed in at least two separate steps. At least one of these being at an elevated temperature to increase the malleability of the blank. The method may involve a surface-grinding step that can increase and improve the contact area and flatness of the electrical contact (ridge). The method also enables flow ports in the form of holes through the plate to be achieved by punching, a less expensive and quicker alternative to drilling. The technique is inherently scalable and may be used to form electrolysis cells of any size.

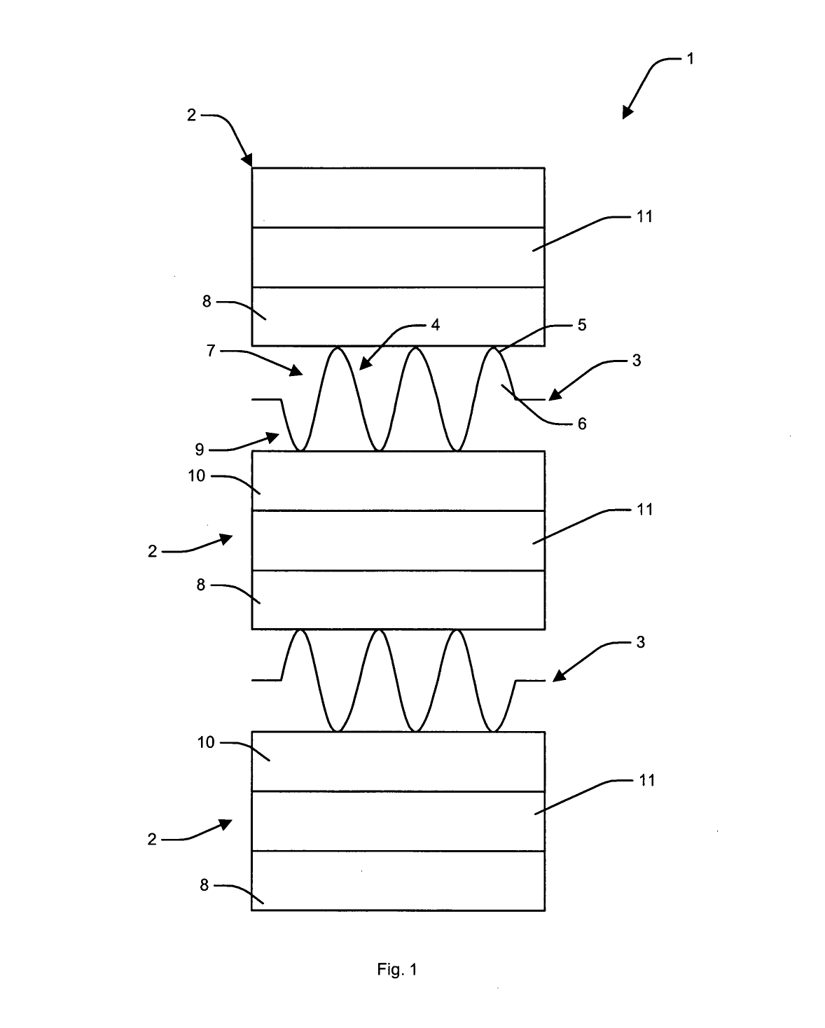

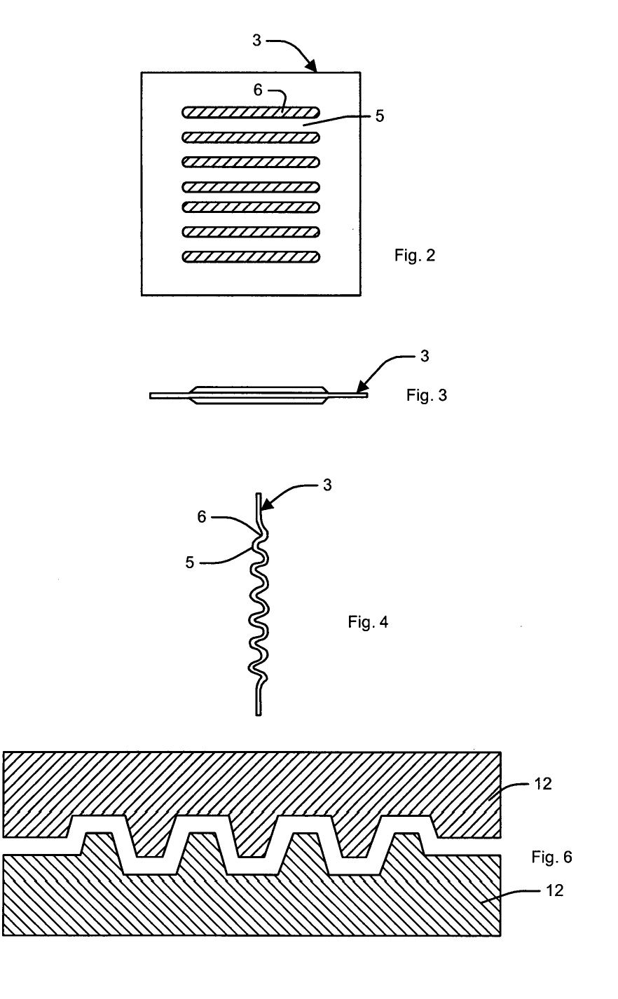

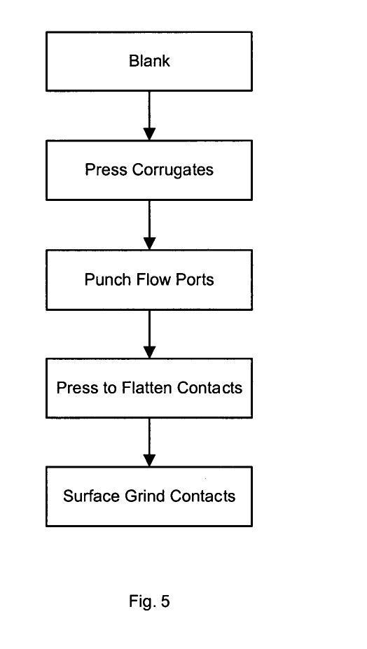

As most clearly shown in FIGS. 4 and 6, there is some degree of asymmetry in the pressing. Either one side must have one more ridge than the other or, with an equal number of ridges, the opposing sets of ridges are laterally displaced by one half of the ridge spacing, which may be a less-acceptable asymmetry. In FIG. 4, there are seven ridges on one side and six on the other. Such asymmetry would be insignificant where there is a large number of ridges (e.g. more than ten ridges).

To reduce stresses on the MEA, the electrical contacts are aligned by arranging the pressed interconnects in a back-to-back arrangement such that opposing contact points of the interconnect on either side of the MEA are aligned. With the above design, this would result in an alternating series of 6-ridge and 7-ridge cells through the stack.

The plates can be formed through the use of a meshing pair of dies in a conventional hydraulic press (not shown). It has been found that a simple die shape incorporating parallel-sided “teeth” is no less effective than the sloping-sided design shown in FIG. 6. Although the material is not tightly constrained between alternate ridges during forming, it tends to assume an approximately sinusoidal form, the particular shape of which is not critical.

It should be noted that the FIG. 6 is an illustrative sketch and may not be ideal depending on the operation of a set of press tools. It does not take into account the fact that the stretched material becomes reduced in thickness. As such, the wide flats shown as being formed on the tops of the ridges would fail to materialize because the thinner material failed to contact the outer “flat” of the opposing tool piece. A gently rounded ridge would be produced which would give a notional line contact (as distinct from area contact) with the cell electrode. Moreover, the tops of the ridges would not be co-planar because the degree of stretching and thinning is not constant, being greater at the middle ridges than at the outer ridges.

Using dies with parallel-sided teeth, it has been found that plates having the approximate shape of FIGS. 2, 3 and 4 can be pressed using approximately 50 tonnes of force over a working area of 50 cm² with 0.7 mm thick titanium sheet. The degree of rounding on the tops of the teeth has a significant affect on the final amplitude of the plate and on the likelihood of fracturing it. Smaller amplitudes of 2 mm or less are more reliably achieved at the 4 mm ridge pitch shown.

It has been found that better results are obtained by using 2 stages of pressing. The first stage uses a pair of toothed dies to create an initial “overpress” and then another set of dies with no teeth, just flat surfaces of slightly smaller amplitude is used to flatten the high points, effectively providing the desired flat surface at the tops of the ridges. It has also been found to be effective to operate the second press at a higher temperature to remove residual stresses and to get bipolar plates substantially free of warp. The actual temperature would depend on the actual metal or alloy used and the thickness of the sheet. In the case of titanium sheet of 0.7 mm thickness, the suitable temperature was in the 250-350° C. range and provided excellent stress relief, producing a final plate that is quite flat and substantially warp-free.

It is difficult to achieve a width of the flats of much greater than 1 mm within a 4 mm pitch. In order to reduce contact resistance between MEAs and bipolar plate and to increase the electrolysis efficiency, the ridge area contacting the MEA must be optimised. Therefore, to optimise width of contact ridges, an additional surface-grinding step has been found to be practical and to readily increase the ridge width to at least 1.3 mm. An additional advantage of this step is that a high degree of thickness uniformity can be achieved in the plate, leading to uniform contact pressure in an assembled stack.

Depending on the material used and the design of the pressing die, plates may shrink slightly in size when pressed. Shrinkage may be non-uniform and lead to a slight “pin-cushioning” in shape, so that the pressed plate has concave edges. Consequently, the location of flow ports and other holes or features outside the active area may move inwards during the pressing process. Accordingly, it is preferred to make such holes (by punching or drilling) in a separate step after the first pressing. This is followed by the second pressing. The second pressing is a stress relief and a flattening stage which does not introduce any substantial additional lateral shrinkage. This flattening can be used to advantage to assist in de-burring and finishing the edges of any holes.

The same combination of press tools may also be used to form other malleable metals, particularly mild steel, nickel and copper sheet. Stainless steel is significantly less malleable and may require substantially higher press tonnages as well as detail differences in the press tool, particularly in relation to the depth and shape of teeth. These materials may require coating to manage corrosion before they can be used in an electrolysis cell. Metallic coating may also be considered to smooth the surface and improve the contact resistance of the interconnect. Titanium has a relatively high electrical resistivity and thermal resistivity, as well as the tendency to form thick oxide coatings giving it a high surface resistance. Coating with other non-corroding metals or alloys may significantly improve the overall efficiency. Other metals such as copper have been successfully pressed and offer the prospect of considerably better electrical and thermal properties.

An example of the use of this invention is a single-cell electrolyser with 50 cm² active area which has been constructed using pressed titanium plates. It has operated successfully at currents of 0.5 A/cm² and higher for a period of 3000 hours. It has run over this entire period sharing a common current with a cell made of similar components, except for the use of a machined titanium plate. The pressed plate cell has been demonstrated to have durability at least equivalent to the machined-plate cell with only a marginal loss in electrolysis efficiency.

Another example of this invention has been the construction of a 4-cell stack using pressed titanium plates with an active area of 50 cm² per cell. This stack achieved a peak overall efficiency of 70% with best cell in the stack achieving an individual efficiency of 74% at a current density of 1 A/cm².

Another example of this invention is a single-cell electrolyser with 50 cm² active area using pressed titanium plates, employing an additional sputtered metallic coating on both plates. This coating has been designed to minimize contact resistance between the plate and the cell electrodes. This cell achieved a peak efficiency of 79% at a current density of 1 A/cm².

Another example of this invention employed a very simple manufacturing procedure using a single stage titanium pressing and no surface grinding to produce a single-cell electrolyser with an active area of 50 cm². This cell achieved a peak efficiency of 69% at a current density of 1 A/cm².

As another example, metals other than titanium (copper and mild steel) were pressed using pressing dies similar to the ones used for titanium with successful moulding of channels and ridges.

In another variation, a number of design variations are possible, for example, spiral, serpentine, or co-flow configurations.

The design can be extended to make channels/ridges to be made in two or more separate parts of the same plate to allow several cells to be placed in parallel. This will provide some redundancy, for example, if one cell in the parallel array is showing high resistance then the current will be carried by other cells.

Although the present invention has been described with particular reference to certain preferred embodiments thereof, variations and modifications of the present invention can be effected within the spirit and scope of the following claims.

We claim:

1. A method of forming a bipolar interconnect for an electrochemical cell stack, the method including:
providing a planar electrically-conductive blank; and
deforming a portion of the conductive blank to provide a raised part on the blank defining an electrical contact and a fluid flow channel.

2. A method as claimed in claim 1 wherein the portion is deformed to provide a raised part in the form of a series of corrugates, defining a plurality of electrical contacts and a plurality of fluid flow channels.

3. A method as claimed in claim 1 wherein the blank is a blank of sheet metal between 0.4 and 1.0 mm thick.

4. A method as claimed in claim 1 wherein the deforming of the portion includes a first pressing operation.

5. A method as claimed in claim 4 wherein the first pressing operation includes pressing the portion of the conductive blank between complementary dies.

6. A method as claimed in claim 5 including heating the conductive blank to a predetermined temperature.

7. A method as claimed in claim 6 including flattening each electrical contact to increase its contact area.

8. A method as claimed in claim 7 wherein the flattening of each electrical contact includes a second pressing operation using a second set of dies and/or grinding the associated contact area.

9. A method as claimed in claim 2 wherein one side of the series of corrugates is associated with an anode of an electrochemical cell in the stack and an opposing side is associated with a cathode of an adjacent electrochemical cell of the stack.

10. A method as claimed in claim 9 wherein the series of corrugates is asymmetrical, one side of the blank having one more electrical contact than an opposing side.

11. A method as claimed in claim 9 wherein the blank has a series of corrugates on two opposing sides, the two series of corrugates being asymmetrical, the series of corrugates on one side of the blank being laterally displaced from the series of corrugates on the opposing side.

12. A method as claimed in claim 9 wherein the conductive blank includes a periphery bounding the series of corrugates, the periphery lying substantially in a central plane such that the corrugates extend about the central plane.

13. A method as claimed in claim 12 wherein at least one flow port is formed in the blank.

14. A method as claimed in claim 13 wherein the flow port is formed by one of a punching operation and a drilling operation.

15. A method as claimed in claim 14 wherein at least two sets of flow ports are formed around the series of corrugates.

16. A method as claimed in claim 1 wherein the conductive blank is formed of a metal.

17. A method as claimed in claim 16 wherein the metal is one of titanium, stainless steel, mild steel, nickel, copper and alloys thereof.

18. A method as claimed in claim 16 wherein the metal is coated with a corrosion resistant material.

19. A method as claimed in claim 16 wherein the metal is coated with a low contact resistance material.

20. A method as claimed in claim 1 wherein the raised part is one of spiral, serpentine, counter or co-flow.

21. A method as claimed in claim 1 wherein the raised part is in the form of a predetermined number of ridges, defining a predetermined number of electrical contacts and a predetermined number of fluid flow channels.

22. A method as claimed in claim 1 wherein a plurality of raised parts are provided on the blank to allow the blank to make electrical contact with a plurality of electrochemical cells in parallel.

23. A bipolar interconnect for an electrochemical cell stack formed using the method of any one of claims 1-22.

24. An electrochemical cell stack including:
a plurality of electrochemical cells arranged in a stack;
a plurality of bipolar interconnects, each interconnect being disposed between adjacent cells and including a series of pressed corrugates such that each corrugate defines an electrical contact and a fluid flow path,
wherein one side of the series of corrugates is associated with an anode of one of the electrochemical cells and the other side of the series of corrugates is associated with a cathode of an adjacent cell.

25. An electrochemical cell stack as claimed in claim 24 wherein the series of corrugates is asymmetrical, one side of the blank having one more electrical contact than an opposing side.

26. An electrochemical cell stack as claimed in claim 24 wherein the blank has a series of corrugates on two opposing sides, the two series of corrugates being asymmetrical, the series of corrugates on one side of the blank being laterally displaced from the series of corrugates on the opposing side.

27. An electrochemical cell stack as claimed in claim 24 wherein consecutive interconnects are arranged back-to-back such that opposing electrical contacts are aligned.

28. An electrochemical cell stack as claimed in claim 24 including a header channel interconnecting at least some of said fluid flow channels.

29. An electrochemical cell stack as claimed in claim 24 wherein the interconnects are more than 0.4 mm thick and of sufficiently high thermal conductivity for uniform heat distribution and heat removal.
